(19) United States
(12) Patent Application Publication
(10) Pub. No.: US 2012/0287917 A1
(43) Pub. Date: Nov. 15, 2012

(54) Common Channel Configuration to Facilitate Measurement for Handover in TD-SCDMA Systems

(75) Inventors: Tom Chin, San Diego, CA (US); Guangming Shi, San Diego, CA (US); Kuo-Chun Lee, San Diego, CA (US)

(73) Assignee: Qualcomm Incorporated, San Diego, CA (US)

(21) Appl. No.: 13/379,711

(22) PCT Filed: Apr. 5, 2010
(86) PCT No.: PCT/US10/29918

§ 371 Date: Dec. 21, 2011

Related U.S. Application Data
(60) Provisional application No. 61/243,962, filed on Sep. 18, 2009.

(51) Int. Cl. H04J 3/06; H04W 92/18

(52) U.S. Cl. 370/347

(57) ABSTRACT

A method of wireless communication includes communicating information with a neighbor Node B in a subframe. The information is associated with uplink timing. The method includes communicating with a serving Node B in the subframe.

### CROSS-REFERENCE TO RELATED APPLICATIONS

This application claims the benefit of U.S. Provisional Patent Application No. 61/243,962, entitled “COMMON CHANNEL CONFIGURATION TO FACILITATE MEASUREMENT FOR HANDOVER IN TD-SCDMA SYSTEMS,” filed on Sep. 18, 2009, which is expressly incorporated by reference herein in its entirety.

### BACKGROUND

1. Field

The present disclosure relates generally to communication systems, and more particularly, to a common channel configuration to facilitate measurement for handover in TD-SCDMA systems.

2. Background

Wireless communication networks are widely deployed to provide various communication services such as telephony, video, data, messaging, broadcasts, and so on. The networks may be multiple access networks capable of supporting communications for multiple users by sharing the available network resources. An example of such a network is a Universal Terrestrial Radio Access Network (UTRAN). UTRAN is the Radio Access Network (RAN) that is part of the Universal Mobile Telecommunications System (UMTS), a third generation (3G) mobile phone technology promulgated by the “3rd Generation Partnership Project” (3GPP). UMTS, which is the successor to Global System for Mobile Communications (GSM), currently uses various standards including Wideband Code Division Multiple Access (WCDMA), High Speed Downlink Packet Data (HSDPA), Time Division-Code Division Multiple Access (TD-CDMA), and Time Division-Synchronous Code Division Multiple Access (TD-SCDMA). By way of example, China is pursuing TD-SCDMA as the underlying air interface in the UTRAN architecture with the existing GSM infrastructures for the core network.

As the demand for mobile broadband access continues to increase, there exists a need for further improvements in UMTS technology. In particular, there exists a need for an improved common channel configuration that facilitates measurement for handover in TD-SCDMA systems.

### SUMMARY

In an aspect of the disclosure, a method of wireless communication includes communicating information with a neighbor Node B in a subframe. The information is associated with uplink timing. The method further includes communicating with a serving Node B in the subframe.

In an aspect of the disclosure, an apparatus of wireless communication includes means for communicating information with a neighbor Node B in a subframe. The information is associated with uplink timing. The apparatus further includes means for communicating with a serving Node B in the subframe.

In an aspect of the disclosure, a computer program product includes a computer-readable medium. The computer-readable medium includes code for communicating information with a neighbor Node B in a subframe. The information is associated with uplink timing. The computer-readable medium further includes code for communicating with a serving Node B in the subframe.

In an aspect of the disclosure, an apparatus for wireless communication includes at least one processor and a memory coupled to the at least one processor. The at least one processor is configured to communicate information with a neighbor Node B in a subframe. The information is associated with uplink timing. The at least one processor is further configured to communicate with a serving Node B in the subframe.

### BRIEF DESCRIPTION OF THE DRAWINGS

FIG. 1 is a conceptual diagram illustrating an example of a telecommunications system.

FIG. 2 is a conceptual diagram illustrating an example of a channel structure in a telecommunications system.

FIG. 3 is a conceptual diagram illustrating an example of a Node B in communication with a UE in a telecommunications system.

FIG. 4 illustrates a synchronization requirement of TD-SCDMA systems.

FIG. 5 illustrates an algorithm for estimating uplink timing.

FIG. 6 shows an exemplary channel configuration.

FIG. 7 shows communication using the exemplary channel configuration.

FIG. 8 is a flow chart of a method of wireless communication.

### DETAILED DESCRIPTION

The detailed description set forth below, in connection with the appended drawings, is intended as a description of various configurations and is not intended to represent the sole configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

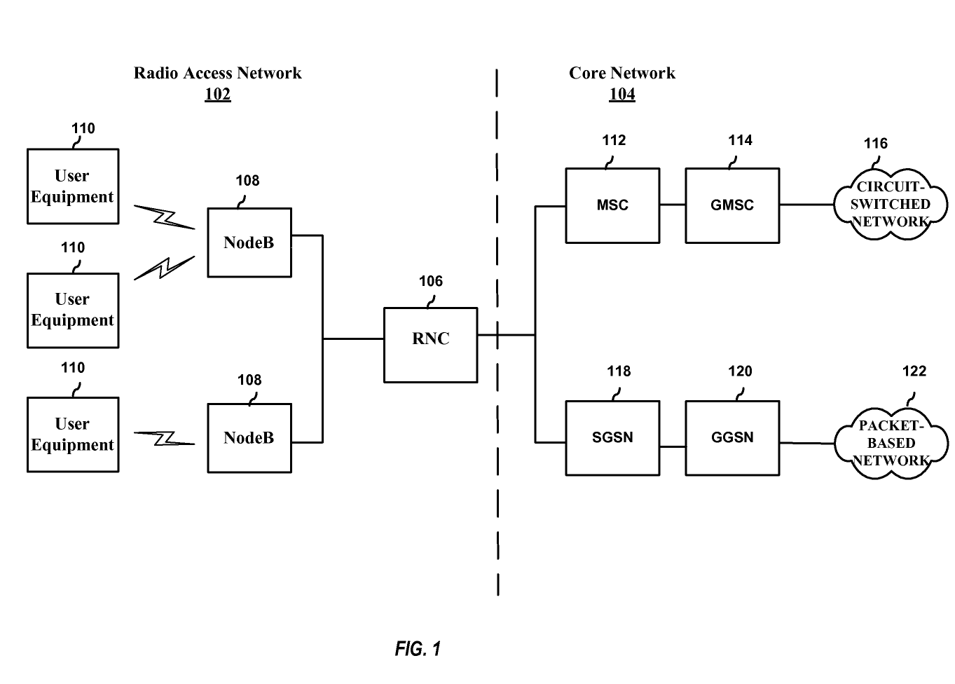

FIG. 1 is a conceptual diagram illustrating an example of a telecommunications system. Various concepts presented throughout this disclosure may be utilized across a broad array of telecommunication systems, network architectures and communication standards. One non-limiting example will now be presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of Radio Network Subsystems (RNS), each controlled by a Radio Network Controller (RNC). Only one RNC 106 is shown for illustrative purposes, however, the RAN 102 may include any number of RNCs. The RNC 106 is an apparatus responsible for, among other things, assigning, reconfiguring and releasing radio resources within the RNS. The RNC 106 may be interconnected to other RNCs in the RAN 102 through an interface comprising a direct physical connection or a virtual network using any suitable transport network.

The geographic region covered by the RNS may be divided into a number of cells, with a radio transceiver apparatus serving each cell. The radio transceiver apparatus is commonly referred to as a Node B in UMTS applications, but may also be referred to by those skilled in the art as a base station, a base transceiver station, a radio base station, a radio transceiver, a transceiver function, a basic service set (BSS), an extended service set (ESS), or some other suitable terminology. Two Node Bs 108 are shown for illustrative purposes, however, the RNS may include any number of wireless Node Bs 108. The Node Bs 108 provide wireless access points to a core network 104 for any number of mobile apparatuses. Examples of a mobile apparatuses include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For illustrative purposes, three UEs 110 are shown in communication with the Node Bs 108.

The core network 104 is shown as a GSM core network. However, as those skilled in the art will recognize, the various concepts presented throughout this disclosure may be implemented in a RAN, or other suitable access network, to provide UEs with access to other core networks.

In this example, the core network 104 supports circuit-switched services with a Mobile Switching Center (MSC) 112 and a Gateway MSC (GMSC) 114. One or more RNCs may be connected to the MSC 112. The MSC 112 is an apparatus that controls call setup, call routing, and UE mobility functions. The MSC 112 also includes a Visitor Location Register (VLR) (not shown) that contains subscriber related information for the duration that a UE is in the coverage area of the MSC 112. The GMSC 114 provides a gateway for the UE to a Public Switched Telephone Network (PSTN) 116. The GMSC 114 includes a Home Location Register (HLR) (not shown) which contains subscriber data, such as the details of the services to which a user has subscribed. Associated with an HLR is an Authentication Center (AuC) that contains subscriber specific authentication data. The GMSC 114 is responsible for querying the HLR when a call is received for a UE to determine its location and for forwarding the call to the MSC serving that location.

The core network 104 also supports packet-data services with a Serving GPRS Support Node (SGSN) 118 and a Gateway GPRS Support Node (GGSN) 120. GPRS, which stands for General Packet Radio Service, which is designed to provide packet-data services at higher speeds than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a Direct-Sequence Code Division Multiple Access (DS-CDMA) system. DS-CDMA means that user data is spread over a much wider bandwidth through multiplication by a sequence of pseudorandom bits called chips. The TD-SCDMA standard calls for a Time Division Duplex (TDD) system. TDD systems use the same carrier for both the uplink (UL) and downlink (DL) between a Node B 108 and a UE 110. The duplexing is based on time and not frequency, as is done typically with Frequency Division Duplex (FDD).

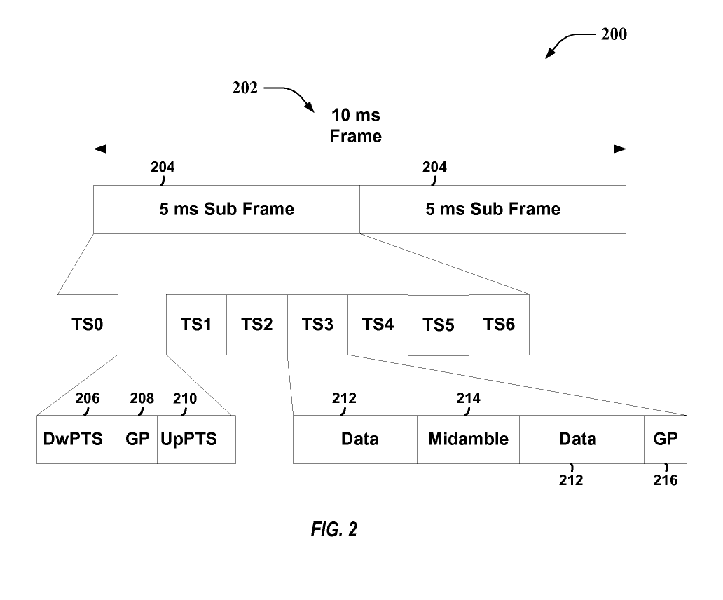

FIG. 2 shows the channel structure 200 for a TD-SCDMA carrier. The carrier has a frame 202 that is 10 ms in length. The frame 202 is made up of two 5 ms subframes 204, and each subframe 204 is made up of seven time slots TS0 through TS6. The first time slot is TS0 and the last time slot is TS6. The first time slot, TS0, is for DL only. The second time slot, TS1, is for UL only. The remaining time slots TS2 through TS6 may be utilized for UL or DL, which can provide for flexibility.

Between TS0 and TS1 are a DL pilot time slot (DwPTS) 206, a guard period (GP) 208, and a UL pilot time slot (UpPTS) 210 (also known as the UL pilot channel (UpPCH)). Each time slot TS0-TS6 may have 16 channelization codes. Each of these channelization codes includes two separate data portions 212 separated by a midamble 214 and followed by a guard period (GP) 216. The midamble 214 may be used for channel estimation and the GP 216 may be used to avoid inter-burst interference.

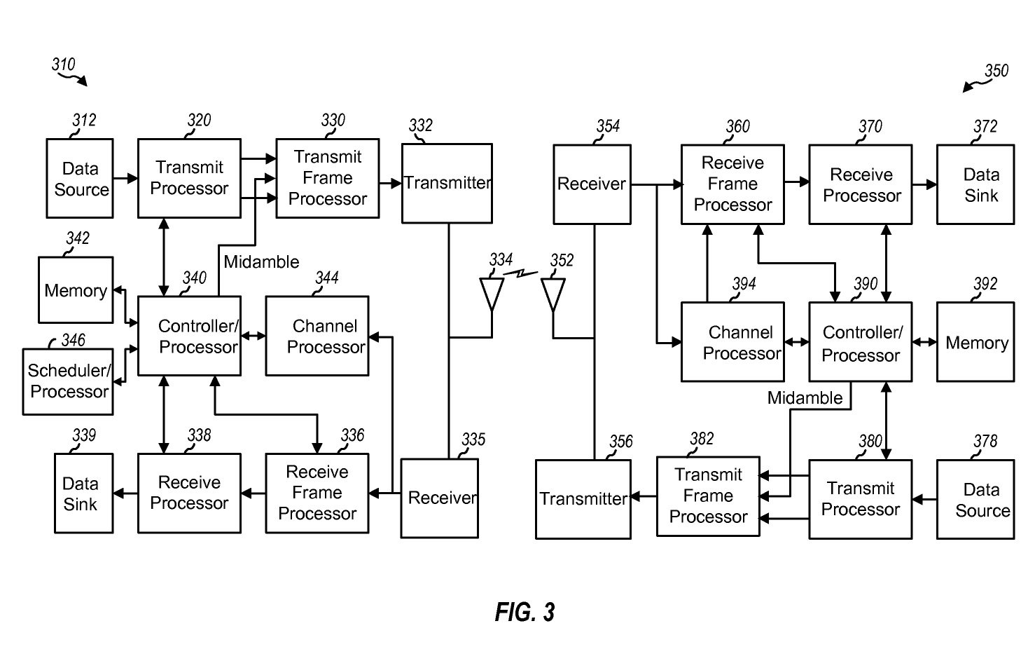

FIG. 3 is a block diagram of a Node B 310 in communication with a UE 350 in a RAN. In the DL, a transmit processor 320 may receive data from a data source 312 and control signals from a controller/processor 340. The transmit processor 320 provides various signal processing functions for the data and control signals, as well as reference signals (e.g., pilot signals). By way of example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)), spreading with Orthogonal Variable Spreading Factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. The channel estimates may be derived from a reference signal transmitted by the UE 350 or feedback contained in the midamble from the UE 350. The symbols generated by the transmit processor 320 may be provided to a transmit frame processor 330 to create a channel structure by multiplexing the symbols with a midamble from the controller/processor 340 to create a series of frames. The frames may then be provided to a transmitter 332, which provides various signal conditioning functions including amplification, filtering, and modulating the frames onto a carrier for DL transmission over the wireless medium through smart antennas 334. The smart antennas 334 may be implemented with beam steering bidirectional adaptive antenna arrays.

At the UE 350, a receiver 354 receives the DL transmission through an antenna 352 and processes the transmission to recover the information modulated onto the carrier. The information recovered by the receiver 354 is provided to a receive frame processor 360. The receive frame processor 360 parses each frame, and provides the midamble to a channel processor 394 and the data, control, and reference signals to a receive processor 370. The receive processor 370 performs the inverse processing done by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control and reference signals. The CRCs are then checked to determine whether the frames were successfully decoded. The data carried by the successfully decoded frames may be provided to a data sink 372. The data sink 372 represents applications running in the UE 350 and various user interfaces (e.g., display). Control signals carried by successfully decoded frames may be provided to a controller/processor 390. The controller/processor 390 may also use an acknowledgement (ACK) and/or negative acknowledgement (NACK) protocol to support retransmission requests for frames that were unsuccessfully decoded by the receive processor 370.

In the UL, data from a data source 378 and control signals from the controller/processor 390 are provided to a transmit processor 380. The data source 378 may represent applications running in the UE 350 and various user interfaces (e.g., keyboard). Similar to the functionality described in connection with the DL transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates derived by the channel processor 394 from a reference signal transmitted by the Node B 310 or feedback contained in the midamble transmitted by the Node B 310 may be used to select the appropriate coding, modulation, spreading and/or scrambling schemes. The symbols produced by the transmit processor 380 may be provided to a transmit frame processor 382 to create a channel structure by multiplexing the symbols with a midamble from the controller/processor 390 to create a series of frames. The frames may then be provided to a transmitter 356, which provides various signal conditioning functions including amplification, filtering, and modulating the frames onto a carrier for UL transmission over the wireless medium through the antenna 352.

The UL transmission is processed at the Node B 310 in a manner similar to that described in connection with the receiver function at the UE 350. A receiver 335 receives the UL transmission through the antenna 334 and processes the transmission to recover the information modulated onto the carrier. The information recovered by the receiver 335 is provided to a receive frame processor 336. The receive frame processor 336 parses each frame, and provides the midamble to the channel processor 344 and the data, control, and reference signals to a receive processor 338. The receive processor 338 performs the inverse processing done by the transmit processor 320 in the Node B 310. The data carried by the successfully decoded frames may be provided to a data sink 339. Control signals carried by successfully decoded frames may be provided to the controller/processor 340. The controller/processor 340 may also use an ACK and/or NACK protocol to support retransmission requests for frames that were unsuccessfully decoded by the receive processor 338.

The controller/processors 340 and 390 may be used to direct the operation at the Node B 310 and the UE 350, respectively. By way of example, the controller/processors 340 and 390 may provide various functions including timing, peripheral interfaces, voltage regulation, power management, and other control functions. Memories 342 and 392 may store data and software for the Node B 310 and the UE 350, respectively. A scheduler/processor 346 at the Node B 310 may be used to allocate resources to the UEs and schedule DL and/or UL transmissions for the UEs.

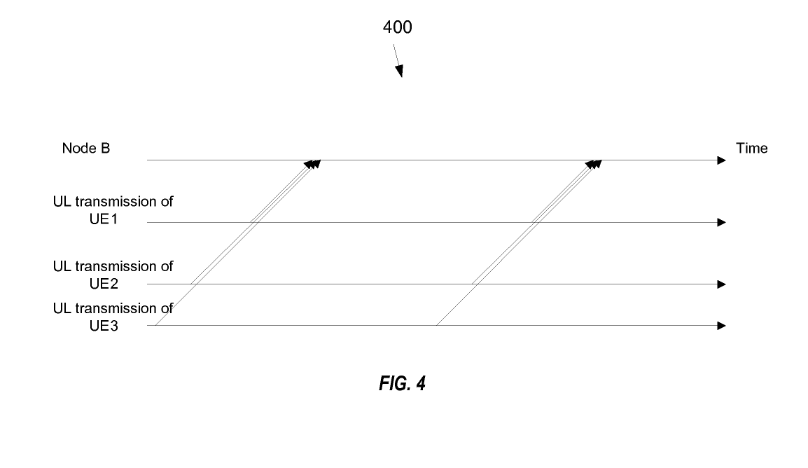

FIG. 4 is a chart 400 illustrating a synchronization requirement of TD-SCDMA systems. In TD-SCDMA systems, different UEs need to synchronize on the UL such that all of the transmitted signals of the UEs arrive at the Node B at the same time. Accordingly, a UE near the Node B transmits later than a UE far from the Node B. As such, as shown in the chart 400, UE3, which is the furthest from the Node B, must transmit on UL earlier than UE1 and UE2. In addition, UE2, which is further from the Node B than UE 1, must transmit on UL earlier than UE1.

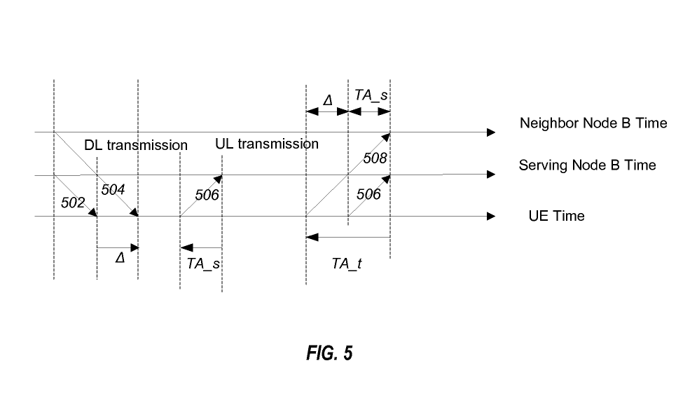

FIG. 5 is a chart 500 illustrating an algorithm for estimating UL timing. In TD-SCDMA handover, UEs need to measure the DL signal quality of neighbor cells in order to select a neighbor cell for handover. The measurement can also be used to acquire initial UL transmission parameters in handover, such as the UL timing advance required for UL synchronization. However, this procedure assumes that the TD-SCDMA Node Bs are synchronous.

In synchronous systems, the UL timing can be estimated by comparing the DL timing difference between the serving cell (502) and the neighbor cell (504), Δ(Δ>0 if the neighbor cell DL (504) arrives later than the serving cell DL (502)). Since the TD-SCDMA network is synchronous, the UL time advance TA_t of the neighbor cell (508) can be estimated by the UL time advance TA_s of the serving cell (506) plus the DL timing difference Δ. That is, TA_t=TA_s+Δ.

However, this algorithm assumes the DL and UL timing and channel are reciprocal; the Node Bs are perfectly synchronous, or the error is only fractional of a chip (there is 1.28 Mega chips per second); and the channel condition does not impair the measurement results. In reality, DL and UL are not reciprocal and the channel may have multipath fading, which can affect the accuracy of the measurement. In addition, the Node Bs may not receive the GPS signal properly and maintain the synchronous condition.

As such, the most accurate method is to use a closed loop measurement method. In the closed loop measurement method, UEs send SYNC_UL (UL Synchronization) code on the UpPTS on UL and receive timing correction and power level command on the FPACH (Fast Physical Access Channel). However, a problem of the closed loop measurement is that the UEs are transmitting and receiving bursts on the DPCH (Dedicated Physical Channel) with the serving cell and cannot transmit SYNC_UL code and receive information on the FPACH with a neighbor cell at the same time.

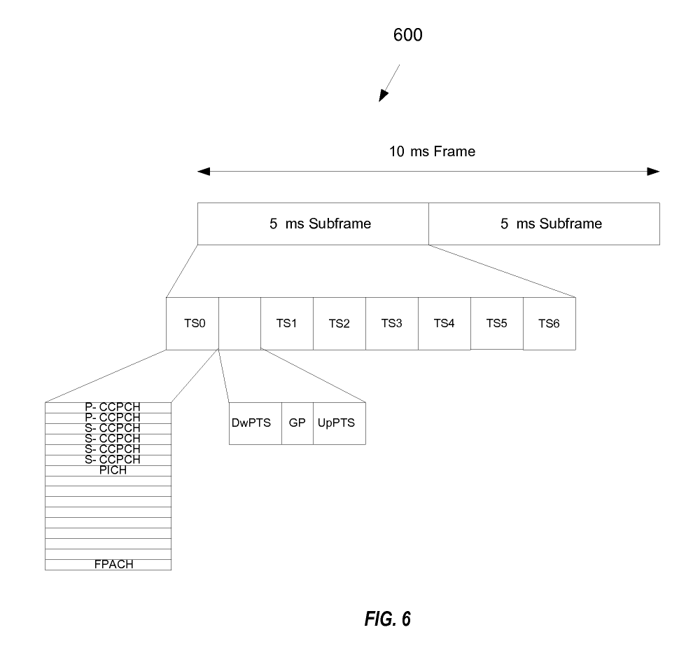

FIG. 6 is an illustration 600 showing an exemplary channel configuration. In an exemplary method, a close-loop pre-synchronization or pre-power control scheme is provided in the TD-SCDMA systems by allocating the common channels properly. In order to allow UEs to communicate concurrently with two cells at one time, all the Node Bs in a radio network controller (RNC) configure the physical channels and TS resources such that (1) FPACH is in TS0 and (2) DPCH is in TS1 through TS6. In one configuration, FPACH is in a subset of the subframes and in TS0 only, and DPCH is in a remaining subset of subframes in TS0. For example, FPACH and DPCH may alternate each subframe in TS0, with FPACH in TS0 for the first 5 ms subframe and DPCH in TS0 for the second 5 ms subframe for each 10 ms frame. In one configuration, the subset includes all the subframes and the remaining subset includes no subframes (i.e., empty set), such that FPACH in TS0 for all the subframes. In another configuration, the subset includes less than all the subframes and the remaining subset includes the remaining subframes.

In order to fully utilize the TS0 time slot with FPACH (i.e., without DPCH), the P-CCPCH (Primary Common Control Physical Channel), the S-CCPCH (Secondary Common Control Physical Channel), and the PICH (Paging Indicator Channel) may also be in TS0. PICH being in TS0 may save power.

With the above configuration requirements, a UE can transmit and receive bursts in TS1 through TS6 with a serving cell while the UE transmits SYNC_UL code on the UpPCH and receives the timing correction and power level command on the FPACH with a neighbor cell, without conflict. If a serving cell sends timing correction and power level command information at the same time on the FPACH, the UE may choose to listen to either of the FPACH communications. The UE may choose to listen to the FPACH communications from the neighboring cell when the timing and power do not need adjustments with respect to the serving cell.

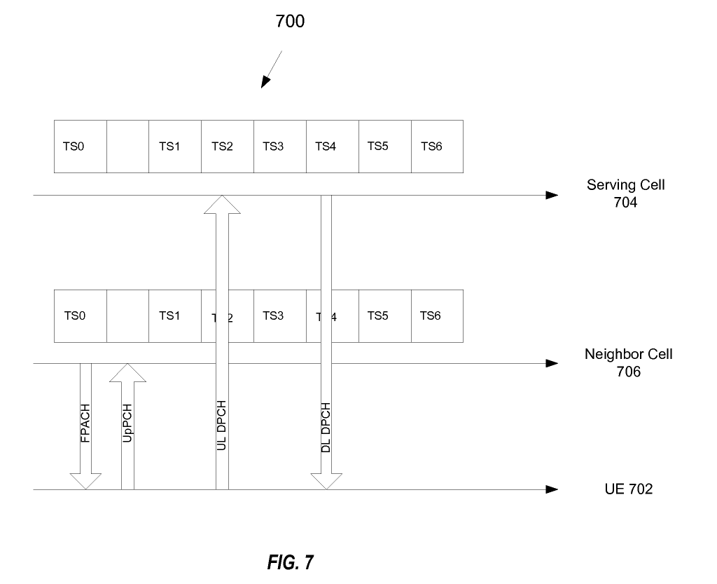

FIG. 7 is an illustration 700 showing communication using the exemplary channel configuration. As shown in FIG. 7, a UE 702 receives timing correction and power level command information on the FPACH in TS0 from the neighbor cell 706, transmits SYNC_UL code on the UpPCH to the neighbor cell 706, and communicates with the serving cell 704 on the DPCH in TS1 through TS6.

As discussed supra, the S-CCPCH and PICH may be in TS0. However, because the Node B may need to transmit at higher power for P-CCPCH, the Node B may not have enough power to transmit data in the S-CCPCH or PICH, and therefore the S-CCPCH and/or PICH may not be configured in TS0.

The exemplary method and apparatus allows a UE to receive timing correction and power level command information with a neighbor cell without affecting data communication through the DPCH with the serving cell and to maintain the throughput while supporting handover procedures.

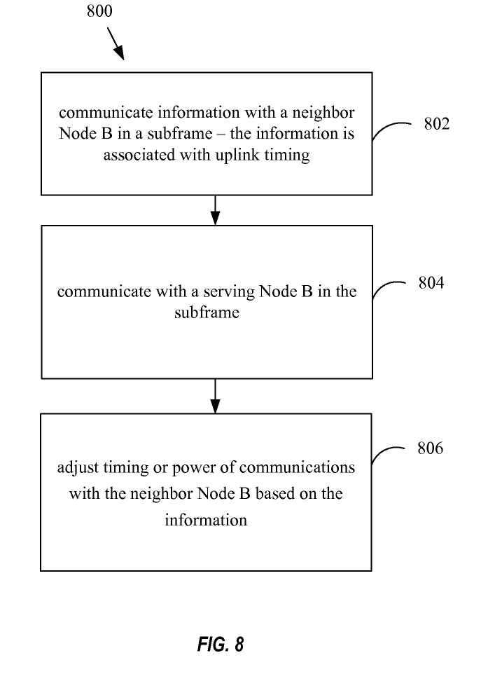

FIG. 8 is a flow chart 800 of a process of wireless communication. The process communicates information with a neighbor Node B in a subframe (802). The information is associated with uplink timing (802). The process communicates with a serving Node B in the subframe (804). In one configuration, the information includes a synchronization pilot transmitted on an uplink pilot channel (UpPCH). In one configuration, the information includes timing correction and power level command information received on a fast physical access channel (FPACH). In one configuration, to communicate the information, the process transmits a synchronization pilot to the neighbor Node B in the subframe. In one configuration, to communicate the information, the process receives timing correction and power level command information from the neighbor Node B in the subframe in response to a synchronization pilot transmitted to the neighbor Node B in a previous subframe. In one configuration, the timing correction and power level information is received in one time slot only of the subframe. In one configuration, communication with the serving Node B occurs in time slots of the subframe other than the one time slot. In one configuration, the one time slot is a first time slot. In one configuration, a primary common control physical channel (P-CCPCH) is utilized in the first time slot only and the process communicates with the neighbor Node B on the P-CCPCH. In one configuration, a secondary common control physical channel (S-CCPCH) is utilized in the first time slot only and the process communicates with the neighbor Node B on the S-CCPCH. In one configuration, a paging indicator channel (PICH) is utilized in the first time slot only and the process communicates with the neighbor Node B on the PICH. In one configuration, the communication with the serving Node B is on a dedicated physical channel (DPCH). In one configuration, the process adjusts timing or power of communications with the neighbor Node B based on the information (806).

In one configuration, the apparatus 350 for wireless communication includes means for communicating information with a neighbor Node B in a subframe. The information is associated with uplink timing. The apparatus 350 further includes means for communicating with a serving Node B in the subframe. The apparatus 350 may further includes means for adjusting timing or power of communications with the neighbor Node B based on the information. The aforementioned means is the receive processor 370, the transmit processor 380, and the controller/processor 390 configured to perform the functions recited by the aforementioned means.

As described supra, timing correction and power level command information is received in DL on the FPACH in TS0 only and data are transmitted/received on the DPCH in TS1 through TS6. However, in another configuration, timing and power information may be received in time slot TSx in which TSx is one of TS2 through TS6. In such a configuration, TSx must be configured for DL only in each of the Node Bs in the RNC. Furthermore, in such a configuration, data are transmitted/received on the DPCH in time slots TS0, TS1, and TS2 through TS6 excluding TSx when TSx carries the FPACH.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as WCDMA, HSPA and TD-CDMA. Various aspects may also be extended to systems employing Long Term Evolution (LTE), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field programmable gate array (FPGA), a programmable logic device (PLD), a state machine, gated logic, discrete hardware circuits, and other suitable processing component configured to perform the various functions described throughout this disclosure. The functionality of a processor, any portion of a processor, or any combination of processors presented in this disclosure may be implemented with software being executed by a microprocessor, microcontroller, DSP, or other suitable platform. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various embodiments presented throughout this disclosure, the memory may be internal to the processors (e.g., cache or register). A computer-readable medium may also include a carrier wave, a transmission line, or any other suitable medium for storing or transmitting software. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
communicating information with a neighbor Node B in a subframe, said information being associated with uplink timing; and
communicating with a serving Node B in the subframe.

2. The method of claim 1, wherein the information comprises a synchronization pilot transmitted on an uplink pilot channel (UpPCH).

3. The method of claim 1, wherein the information comprises timing correction and power level command information received on a fast physical access channel (FPACH).

4. The method of claim 1, wherein the communicating the information comprises transmitting a synchronization pilot to the neighbor Node B in the subframe.

5. The method of claim 1, wherein the communicating the information comprises receiving timing correction and power level command information from the neighbor Node B in the subframe in response to a synchronization pilot transmitted to the neighbor Node B in a previous subframe.

6. The method of claim 5, wherein the timing correction and power level information is received in one time slot only of the subframe.

7. The method of claim 6, wherein the communicating with the serving Node B occurs in time slots of the subframe other than the one time slot.

8. The method of claim 6, wherein the one time slot is a first time slot.

9. The method of claim 8, wherein a primary common control physical channel (P-CCPCH) is utilized in the first time slot only, the method further comprising communicating with the neighbor Node B on the P-CCPCH.

10. The method of claim 8, wherein a secondary common control physical channel (S-CCPCH) is utilized in the first time slot only, the method further comprising communicating with the neighbor Node B on the S-CCPCH.

11. The method of claim 8, wherein a paging indicator channel (PICH) is utilized in the first time slot only, the method further comprising communicating with the neighbor Node B on the PICH.

12. The method of claim 1, wherein the communicating with the serving Node B is on a dedicated physical channel (DPCH).

13. The method of claim 1, further comprising adjusting timing or power of communications with the neighbor Node B based on the information.

14. An apparatus of wireless communication, comprising:
means for communicating information with a neighbor Node B in a subframe, said information being associated with uplink timing; and
means for communicating with a serving Node B in the subframe.

15. The apparatus of claim 14, wherein the information comprises a synchronization pilot transmitted on an uplink pilot channel (UpPCH).

16. The apparatus of claim 14, wherein the information comprises timing correction and power level command information received on a fast physical access channel (FPACH).

17. The apparatus of claim 14, wherein the means for communicating communicates the information by transmitting a synchronization pilot to the neighbor Node B in the subframe.

18. The apparatus of claim 14, wherein the means for communicating communicates the information by receiving timing correction and power level command information from the neighbor Node B in the subframe in response to a synchronization pilot transmitted to the neighbor Node B in a previous subframe.

19. The apparatus of claim 18, wherein the timing correction and power level information is received in one time slot only of the subframe.

20. The apparatus of claim 19, wherein the means for communicating communicates with the serving Node B in time slots of the subframe other than the one time slot.

21. The apparatus of claim 19, wherein the one time slot is a first time slot.

22. The apparatus of claim 21, wherein a primary common control physical channel (P-CCPCH) is utilized in the first time slot only, the apparatus further comprising means for communicating with the neighbor Node B on the P-CCPCH.

23. The apparatus of claim 21, wherein a secondary common control physical channel (S-CCPCH) is utilized in the first time slot only, the apparatus further comprising means for communicating with the neighbor Node B on the S-CCPCH.

24. The apparatus of claim 21, wherein a paging indicator channel (PICH) is utilized in the first time slot only, the apparatus further comprising means for communicating with the neighbor Node B on the PICH.

25. The apparatus of claim 14, wherein the means for communicating communicates with the serving Node B on a dedicated physical channel (DPCH).

26. The apparatus of claim 14, further comprising means for adjusting timing or power of communications with the neighbor Node B based on the information.

27. A computer program product, comprising:
a computer-readable medium comprising code for:
communicating information with a neighbor Node B in a subframe, said information being associated with uplink timing; and
communicating with a serving Node B in the subframe.

28. The computer program product of claim 27, wherein the information comprises a synchronization pilot transmitted on an uplink pilot channel (UpPCH).

29. The computer program product of claim 27, wherein the information comprises timing correction and power level command information received on a fast physical access channel (FPACH).

30. The computer program product of claim 27, wherein the code for communicating communicates the information by transmitting a synchronization pilot to the neighbor Node B in the subframe.

31. The computer program product of claim 27, wherein the code for communicating communicates the information by receiving timing correction and power level command information from the neighbor Node B in the subframe in response to a synchronization pilot transmitted to the neighbor Node B in a previous subframe.

32. The computer program product of claim 31, wherein the timing correction and power level information is received in one time slot only of the subframe.

33. The computer program product of claim 32, wherein the code for communicating communicates with the serving Node B in time slots of the subframe other than the one time slot.

34. The computer program product of claim 32, wherein the one time slot is a first time slot.

35. The computer program product of claim 34, wherein a primary common control physical channel (P-CCPCH) is utilized in the first time slot only, wherein the computer-readable medium further comprises code for communicating with the neighbor Node B on the P-CCPCH.

36. The computer program product of claim 34, wherein a secondary common control physical channel (S-CCPCH) is utilized in the first time slot only, wherein the computer-readable medium further comprises code for communicating with the neighbor Node B on the S-CCPCH.

37. The computer program product of claim 34, wherein a paging indicator channel (PICH) is utilized in the first time slot only, wherein the computer-readable medium further comprises code for communicating with the neighbor Node B on the PICH.

38. The computer program product of claim 27, wherein the code for communicating communicates with the serving Node B on a dedicated physical channel (DPCH).

39. The computer program product of claim 27, wherein the computer-readable medium further comprises code for adjusting timing or power of communications with the neighbor Node B based on the information.

40. An apparatus for wireless communication, comprising:
at least one processor; and
a memory coupled to the at least one processor,
wherein the at least one processor is configured to:
communicate information with a neighbor Node B in a subframe, said information being associated with uplink timing; and
communicate with a serving Node B in the subframe.

41. The apparatus of claim 40, wherein the information comprises a synchronization pilot transmitted on an uplink pilot channel (UpPCH).

42. The apparatus of claim 40, wherein the information comprises timing correction and power level command information received on a fast physical access channel (FPACH).

43. The apparatus of claim 40, wherein the at least one processor is configured to communicate the information by transmitting a synchronization pilot to the neighbor Node B in the subframe.

44. The apparatus of claim 40, wherein the at least one processor is configured to communicate the information by receiving timing correction and power level command information from the neighbor Node B in the subframe in response to a synchronization pilot transmitted to the neighbor Node B in a previous subframe.

45. The apparatus of claim 44, wherein the timing correction and power level information is received in one time slot only of the subframe.

46. The apparatus of claim 45, wherein the at least one processor is configured to communicate with the serving Node B in time slots of the subframe other than the one time slot.

47. The apparatus of claim 45, wherein the one time slot is a first time slot.

48. The apparatus of claim 47, wherein a primary common control physical channel (P-CCPCH) is utilized in the first time slot only, wherein the at least one processor is further configured to communicate with the neighbor Node B on the P-CCPCH.

49. The apparatus of claim 47, wherein a secondary common control physical channel (S-CCPCH) is utilized in the first time slot only, wherein the at least one processor is further configured to communicate with the neighbor Node B on the S-CCPCH.

50. The apparatus of claim 47, wherein a paging indicator channel (PICH) is utilized in the first time slot only, wherein the at least one processor is further configured to communicate with the neighbor Node B on the PICH.

51. The apparatus of claim 40, wherein the at least one processor is configured to communicate with the serving Node B on a dedicated physical channel (DPCH).

52. The apparatus of claim 40, wherein the at least one processor is further configured to adjust timing or power of communications with the neighbor Node B based on the information.
